(19) United States
(12) Patent Application Publication
(10) Pub. No.: US 2004/0203530 A1
(43) Pub. Date: Oct. 14, 2004

(54) Energy saving type vibration device for cellular phone

(76) Inventors: Chi Wang Liang, Jangher City (TW); Chung Heng Yang, Taiping City (TW); Ming-fei Chen, Changhuah City (TW)

Correspondence Address: Keith Kline, PRO-TECHTOR INTERNATIONAL SERVICES, 20775 Norada Court, Saratoga, CA, 95070-3018, US

(21) Appl. No.: 10/340,252

(22) Filed: Jan. 9, 2003

(51) Int. Cl. H04B 1/38; H04M 1/00

(52) U.S. Cl. 455/90.3; 455/567; 455/575.1

(57) ABSTRACT

An energy saving type vibration device for cellular phone comprises a vibration member, a magnetic actuator, elastic means activated by the vibration member, and an electric coil. In response to an incoming call, a magnetic force of the electric coil is generated. The actuator is continuously attracted and repelled for moving back and forth respectively by the magnetic force of the electric coil as cyclic actions of charge and discharge of capacitors. The vibration member is thus capable of generating a resonance for causing the cellular phone to vibrate continuously, thereby informing a user of the incoming call.

### FIELD OF THE INVENTION

The present invention relates to cellular phones and more particularly to a vibration device for cellular phone with improved energy saving characteristics.

### BACKGROUND OF THE INVENTION

Conventionally, a user may switch a cellular phone to a silent mode for preventing a possible incoming call from bothering other persons by its consecutive rings. In detail, an incoming call will trigger a vibrator in the cellular phone to vibrate a housing of the cellular phone. Thus, the user can be informed of the incoming call. A typical vibrator comprises a motor driven by a trigger signal of the incoming call and a cam coupled to and driven by a rotating shaft of the motor. The cam may continuously hit an internal member of the cellular phone for generating a vibration since the rotating shaft of the motor continuously rotates during the vibration process as activated by the incoming call. This may quickly consume a battery's electricity. As a result, a period of service of the cellular phone may be shorten significantly. Thus improvement exists.

### SUMMARY OF THE INVENTION

It is therefore an object of the present invention to provide an energy saving type vibration device mounted in a housing of a cellular phone having a vibration circuit including one or more capacitors, the vibration device comprising a vibration member comprising a plurality of side posts passed therethrough for stably supporting the vibration member and for permitting the vibration member to slide therealong; a magnetic actuator extended downward from about a center of the bottom of the vibration member; an elastic member put on the actuator being urged against the bottom of the vibration member; and an electric coil formed around the actuator; whereby in response to an incoming call, a magnetic force of the electric coil is generated, the actuator is continuously attracted and repelled for moving back and forth respectively by the magnetic force of the electric coil as cyclic actions of charge and discharge of the capacitors, and the elastic member is continuously compressed and expanded for causing the vibration member to slide along the posts and for generating a resonance within the housing for causing the cellular phone to vibrate continuously, thereby informing a user of the incoming call.

In one aspect of the present invention, there are further provided two pivot bars each extended from one end of the vibration member into a chamber in communication with the housing, each of the pivot bars having an enlarged head, and two opposite adjacent upright supports separated between the chamber and the housing wherein in the vibration of the cellular phone, the pivot bars turn about a point between the supports back and forth with a wall of the chamber being hit by the head.

It is another object of the present invention to provide an energy saving type vibration device mounted in a housing of a cellular phone having a vibration circuit including one or more capacitors, the vibration device comprising a vibration member comprising a plurality of side posts passed therethrough for stably supporting the vibration member and for permitting the vibration member to slide therealong and two pivot bars each extended from one end of the vibration member into a chamber in communication with the housing, each of the pivot bars having an enlarged head, and two opposite adjacent upright supports separated between the chamber and the housing; a magnetic actuator extended downward from about a center of the bottom of the vibration member; two elastic members each put on the post being urged against the bottom of the vibration member; and an electric coil formed around the actuator; whereby in response to an incoming call, a magnetic force of the electric coil is generated, the actuator is continuously attracted and repelled for moving back and forth respectively by the magnetic force of the electric coil as cyclic actions of charge and discharge of the capacitors, and the elastic members are continuously compressed and expanded for causing the vibration member to slide along the posts and the pivot bars to turn about a point between the supports back and forth respectively with a wall of the chamber being hit by the head and for generating a resonance within the housing for causing the cellular phone to vibrate continuously, thereby informing a user of the incoming call.

It is still another object of the present invention to provide an energy saving type vibration device mounted in a housing of a cellular phone having a vibration circuit including one or more capacitors, the vibration device comprising an elastic member anchored in a first internal recess; a vibration member having one end connected to an open end of the elastic member and comprising a pivot bar formed at the other end extended into a chamber in communication with the housing, the pivot bar having an enlarged head, and two opposite adjacent upright supports separated between the chamber and the housing; an electric coil formed at a second internal recess; and a magnetic actuator formed on the vibration member adjacent the pivot bar and being disposed corresponding to the electric coil; whereby in response to an incoming call, a magnetic force of the electric coil is generated, the actuator is continuously attracted and repelled for moving back and forth respectively by the magnetic force of the electric coil as cyclic actions of charge and discharge of the capacitors, at the same time the pivot bars turn about a point between the supports back and forth with a wall of the chamber being hit by the head, and in response a resonance is generated within the housing for causing the cellular phone to vibrate continuously, thereby informing a user of the incoming call.

The above and other objects, features and advantages of the present invention will become apparent from the following detailed description taken with the accompanying drawings.

### BRIEF DESCRIPTION OF THE DRAWINGS

FIG. 1 is a side view in part second of a first preferred embodiment of a vibration device for cellular phone according to the invention;

FIG. 2 is a view similar to FIG. 1 showing an operation of the vibration device;

FIG. 3 is a side view in part second of a second preferred embodiment of a vibration device for cellular phone according to the invention;

FIG. 4 is a view similar to FIG. 3 showing an operation of the vibration device of FIG. 3;

FIG. 5 is a side view in part second of a third preferred embodiment of a vibration device for cellular phone according to the invention; and

FIG. 6 is a side view in part second of a fourth preferred embodiment of a vibration device for cellular phone according to the invention.

### DETAILED DESCRIPTION OF THE PREFERRED EMBODIMENTS

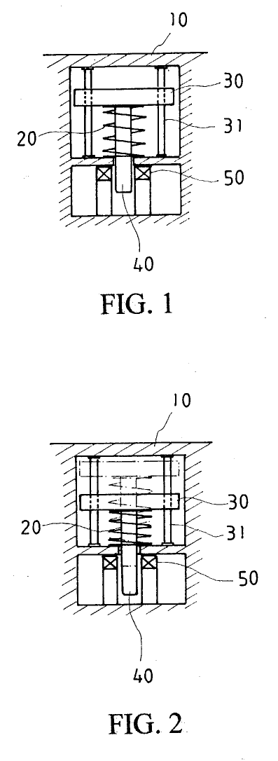

Referring to FIGS. 1 and 2, there is shown a first preferred embodiment of a vibration device mounted in a housing 10 of a cellular phone constructed in accordance with the invention. The vibration device comprises a plate-shaped metal (or non-metal) vibration member 30 having a sufficient rigidity comprising two side posts 31 passed therethrough for stably supporting the vibration member 30 in the housing 10 and for permitting the vibration member 30 to slide therealong, a magnetic actuator rod 40 extended downward from about a center of the bottom of the vibration member 30, an elastic member (e.g., coil spring) 20 put on the actuator rod 40 being urged against the bottom of the vibration member 30, and an electric coil 50 formed around a lower part of the actuator rod 40.

The vibration device is activated in response to an incoming call. Next, a magnetic force of the electric coil 50 is generated by the electrical signal of the incoming call. The actuator rod 40 is then continuously attracted and repelled by the magnetic force of the electric coil 50 as the cyclic actions of charge and discharge of one or more capacitors of a vibration circuit (not shown) of the vibration device. As such, the actuator rod 40 continuously moves down and up. As a result, the elastic member 20 is continuously compressed and expanded for causing the vibration member 30 to slide along the posts 31 back and forth. This may generate a resonance on the housing 10 for causing it to vibrate continuously. Thus, the user can be informed of the incoming call. It is important to note that an optimum vibration quality can be obtained by suitably selecting a mass of the vibration member 30 and an elastic constant and by controlling a resistance of the vibration member 30 under an allowable maximum limit.

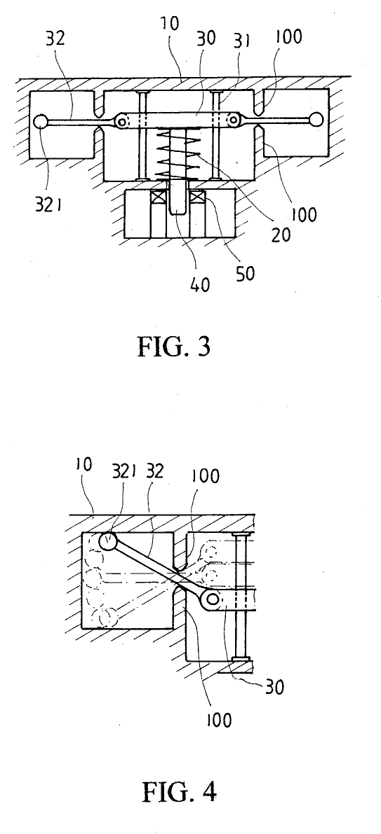

Referring to FIGS. 3 and 4, there is shown a second preferred embodiment of the invention. The characteristics of the second preferred embodiment are detailed below. A pivot bar 32 is formed at either end of the vibration member 30. Most portions of the pivot bar. 32 is disposed in a side chamber in communication with the housing 10. The pivot bar 32 has an enlarged head 321. In vibration, the pivot bar 32 may turn about a point between two opposite upright supports 100 back and forth with the wall of the housing 10 being hit by the head 321. This configuration has the benefit of increasing vibration in addition to the energy saving feature.

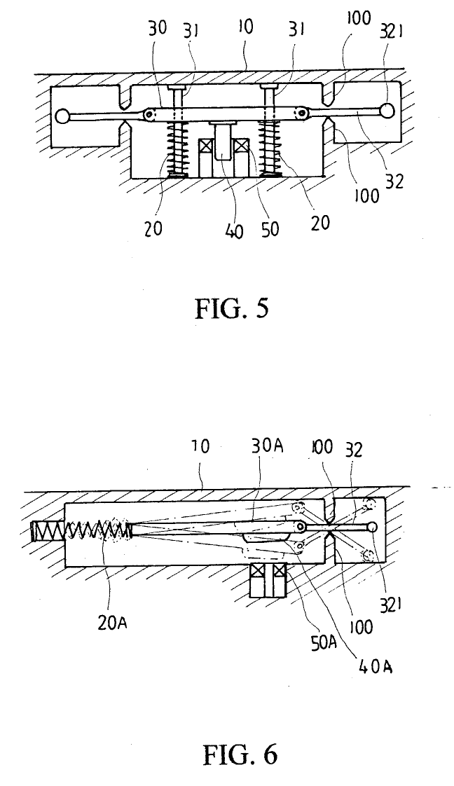

Referring to FIG. 5, there is shown a third preferred embodiment of the invention. The characteristics of the third preferred embodiment are detailed below. As compared with the second preferred embodiment, there are provided a pair of identical second elastic members 20 each put on the post 31 while the previous elastic member 20 put on the actuator rod 40 is eliminated. This configuration has the benefit of smoothing the up-and-down movement of the vibration member 30 in addition to the energy saving feature.

Referring to FIG. 6, there is shown a fourth preferred embodiment of the invention. The characteristics of the fourth preferred embodiment are detailed below. An elastic member (e.g., spring) 20A is anchored in an internal recess of the housing 10. The open end of the elastic member 20 is connected to a vibration member 30A. A pivot bar 32 is formed at the other end (i.e., opposite to the elastic member 20A) of the vibration member 30A. Most portions of the pivot bar 32 is disposed in a chamber. The pivot bar 32 has an enlarged head 321. An actuator rod 40A is formed on the vibration member 30A adjacent the pivot bar 32 and being disposed corresponding to an electric coil 50A at another recess of the housing 10. In vibration, the pivot bar 32 may turn about a point between two opposite upright supports 100 back and forth with the wall of the housing 10 being hit by the head 321. Also, the actuator rod 40A continuously moves up-and-down as repelled and attracted by the magnetic force of the electric coil 50A as the cyclic actions of charge and discharge of one or more capacitors of the vibration circuit of the vibration device. In this state, the vibration member 30A is operated like a member suspended between the elastic member 20A and the supports 110.

While the invention has been described by means of specific embodiments, numerous modifications and variations could be made thereto by those skilled in the art without departing from the scope and spirit of the invention set forth in the claims.

What is claimed is:

1. A vibration device mounted in a housing of a cellular phone having a vibration circuit including one or more capacitors, the vibration device comprising:
a vibration member comprising a plurality of side posts passed therethrough for stably supporting the vibration member and for permitting the vibration member to slide therealong;
a magnetic actuator extended downward from about a center of the bottom of the vibration member;
an elastic member put on the actuator being urged against the bottom of the vibration member; and
an electric coil formed around the actuator;
whereby in response to an incoming call, a magnetic force of the electric coil is generated, the actuator is continuously attracted and repelled for moving back and forth respectively by the magnetic force of the electric coil as cyclic actions of charge and discharge of the capacitors, the elastic member is continuously compressed and expanded for causing the vibration member to slide along the posts, and a resonance is generated within the housing for causing the cellular phone to vibrate continuously, thereby informing a user of the incoming call.

2. The vibration device of claim 1, wherein the vibration member is a plate.

3. The vibration device of claim 1, wherein the actuator is a rod.

4. The vibration device of claim 1, wherein the elastic member is a coil spring.

5. The vibration device of claim 1, further comprising two pivot bars each extended from one end of the vibration member into a chamber in communication with the housing, each of the pivot bars having an enlarged head, and two opposite adjacent upright supports separated between the chamber and the housing wherein in the vibration of the cellular phone, the pivot bars turn about a point between the supports back and forth with a wall of the chamber being hit by the head.

6. A vibration device mounted in a housing of a cellular phone having a vibration circuit including one or more capacitors, the vibration device comprising:
a vibration member comprising a plurality of side posts passed therethrough for stably supporting the vibration member and for permitting the vibration member to slide therealong and two pivot bars each extended from one end of the vibration member into a chamber in communication with the housing, each of the pivot bars having an enlarged head, and two opposite adjacent upright supports separated between the chamber and the housing;
a magnetic actuator extended downward from about a center of the bottom of the vibration member;
two elastic members each put on the post being urged against the bottom of the vibration member; and
an electric coil formed around the actuator;
whereby in response to an incoming call, a magnetic force of the electric coil is generated, the actuator is continuously attracted and repelled for moving back and forth respectively by the magnetic force of the electric coil as cyclic actions of charge and discharge of the capacitors, the elastic members are continuously compressed and expanded for causing the vibration member to slide along the posts and the pivot bars to turn about a point between the supports back and forth respectively with a wall of the chamber being hit by the head, and a resonance is generated within the housing for causing the cellular phone to vibrate continuously, thereby informing a user of the incoming call.

7. The vibration device of claim 6, wherein the vibration member is a plate.

8. The vibration device of claim 6, wherein the actuator is a rod.

9. The vibration device of claim 6, wherein the elastic member is a coil spring.

10. A vibration device mounted in a housing of a cellular phone having a vibration circuit including one or more capacitors, the vibration device comprising:
an elastic member anchored in a first internal recess;
a vibration member having one end connected to an open end of the elastic member and comprising a pivot bar formed at the other end extended into a chamber in communication with the housing, the pivot bar having an enlarged head, and two opposite adjacent upright supports separated between the chamber and the housing;
an electric coil formed at a second internal recess; and
a magnetic actuator formed on the vibration member adjacent the pivot bar and being disposed corresponding to the electric coil;
whereby in response to an incoming call, a magnetic force of the electric coil is generated, the actuator is continuously attracted and repelled for moving back and forth respectively by the magnetic force of the electric coil as cyclic actions of charge and discharge of the capacitors, at the same time the pivot bars turn about a point between the supports back and forth with a wall of the chamber being hit by the head, and a resonance is generated within the housing for causing the cellular phone to vibrate continuously, thereby informing a user of the incoming call.

11. The vibration device of claim 10, wherein the elastic member is a coil spring.
